(19) United States
(12) Patent Application Publication
(10) Pub. No.: US 2015/0264668 A1
(43) Pub. Date: Sep. 17, 2015

(54) WIRELESS COMMUNICATION SYSTEM

(71) Applicant: SHARP KABUSHIKI KAISHA, Osaka (JP)

(72) Inventors: Shuichi Takehana, Osaka-shi (JP); Hidenobu Fukumasa, Osaka-shi (JP); Toshiaki Kameno, Osaka-shi (JP); Shusaku Fukumoto, Osaka-shi (JP); Yuichi Nobusawa, Osaka-shi (JP)

(73) Assignee: Sharp Kabushiki Kaisha, Osaka (JP)

(21) Appl. No.: 14/435,497

(22) PCT Filed: Dec. 3, 2013
(86) PCT No.: PCT/JP2013/082421

§ 371 Date: Apr. 14, 2015

(30) Foreign Application Priority Data
Feb. 13, 2013 (JP) 2013-025503

(51) Int. Cl. H04W 72/04; H04W 4/00

(52) U.S. Cl. CPC H04W 72/042; H04W 4/005; H04W 88/08

(57) ABSTRACT

A plurality of MTC devices can connect to a base station device efficiently. The base station device receives a request signal for requesting access to the base station device from MTC devices in group A that can transmit data to the base station device using a predetermined application data format. The base station device allocates radio resource to an MTC device operating as a gateway, among the MTC devices in group A. The MTC device operating as a gateway receives video data from an MTC device not operating as a gateway in group A. The base station device transmits the video data received from the MTC device not operating as a gateway to the base station device using the allocated radio resource.

### TECHNICAL FIELD

The present invention relates to a wireless communication system, a base station device, a communication device, a communication control method, and a program. More specifically, the present invention relates to a wireless communication system including a plurality of communication devices performing machine communication, a base station device included in the wireless communication system, a communication device, a communication control method in the wireless communication system, the base station device and the communication devices, and a program for controlling the base station device and the communication devices.

### BACKGROUND ART

Conventionally, public wireless communication systems such as LTE (Long Term Evolution) can provide a variety of services to users through packet access. In such public wireless communication systems, the required information rate, delay, and others vary among services. The public wireless communication systems therefore prepare a plurality of classes depending on QoS (Quality of Service) and set a proper bearer for each service. FIG. 19 is a diagram illustrating classification in LTE. Referring to FIG. 19, nine classes are prepared in LTE.

The field of MTC (Machine Type Communication) has recently attracted attention, in which machines perform communication (machine communication) with each other without involving user's operation. MTC finds a wide variety of applications including security, medical care, agriculture, factory automation, and life line control. Among the applications of MTC, in particular, smart grids have attracted attention, which allow efficient transmission and distribution of energy by integrating, for example, information of electric power measured by a measurer called a smart meter, as illustrated in NPD 1 below.

Communications between MTC devices and between an MTC server managing MTC devices and an MTC device are expected to increasingly grow in the future. At present, as described in NPD 2, studies have been carried out to apply a system using a 3GPP (Third Generation Partnership Project) network such as LTE or a system using a short-range communication system in accordance with the IEEE 802.15 standard, to such communications.

MTC involves an extremely large number of devices and thus may require an enormous amount of control signals. In this respect, NPD 2 below proposes a grouping-based MTC management method. In this MTC management method, MTC devices that require various QoS are grouped according to permissible values of QoS, and AGTI (Access Grant Time Interval) corresponding to each group is allocated to each MTC device.

As a communication system for MTC devices, for example, the IDMA (Interleave Division Multiple Access) system is drawing attention, as described in NPD 3 below. According to NPD 3, the advantages of using the IDMA system in MTC communications include eliminating the need for scheduling and effectively applying a multi user interference canceller.

The signal receiving and demodulating processing in the IDMA system will be described below. For a channel in mobile communication, it is particularly effective to use a system called OFDM-IDMA, which uses IDMA and OFDM (Orthogonal Frequency Division Multiplexing) in combination. NPD 4 below explains the principle of the OFDM-IDMA. FIG. 20 is a diagram illustrating the principle of the OFDM-IDMA.

Referring to FIG. 20, each MTC device of each user encodes data to be transmitted with an encoder. Each MTC device then interleaves the encoded data with an interleaver. Each MTC device then modulates the interleaved signal. Each MTC device then performs inverse discrete Fourier transform of the modulated signal. A transmission signal is thus generated in each MTC device. An encoder common to the MTC devices is used. An interleaver different among devices is used.

The signal input to the antenna of a base station device is a mixture of signals from a plurality of MTC devices. The signal input to the antenna of the base station device additionally includes noise and interference. The base station device performs discrete Fourier transform of the signal. The base station device then performs MUD (Multi User Detection) on the signal obtained by discrete Fourier transform. The base station device thus separates the received signal into signals of individual users. MUD extracts a signal component of each user from the signal including a mixture of signals from a plurality of users. MUD adopts a method of gradually reducing interference components through iterative processing for the IDMA signal.

FIG. 21 is a diagram illustrating the operation of MUD. Referring to FIG. 21, the signal DFT-processed in the base station device is sent to an ESE (Elementary Signal Estimator). The ESE obtains the mean and variance for each bit, using Gaussian approximation. The ESE sends the means and variance to a deinterleaver corresponding to the interleaver of the device of each user. The deinterleaver sends the deinterleaved signal (output) to an APP (A Posteriori Probability) decoder. The APP decoder performs decoding of a received sequence of log-likelihoods of channel bits, outputs the decoding result as a decoded signal for each user, and encodes it again for output to the interleaver with improved accuracy of the log-likelihood information. The ESE re-calculates the mean and variance based on the likelihood information of the transmission signal of each user that is sent from each APP decoder. MUD iteratively performs the processing above to increase the accuracy of signal estimation.

Japanese Patent Laying-Open No. 2007-60212 (PTD 1) discloses a configuration using a relay (relay device, repeater) that relays transmission data in uplink communication between a base station device and a portable terminal device.

NPD 5 below describes global standardization trends of cellular technology applied to machine communication.

### CITATION LIST

### Patent Document

PTD 1: Japanese Patent Laying-Open No. 2007-60212
PTD 2: Japanese Patent National Publication No. 2011-511486

### Non Patent Document

NPD 1: Tominaga et al., Smart Grid from the Viewpoint of ICT [II], the Journal of Institute of Electronics, Information and Communication Engineers, Vol. 95, No. 1, 2012
NPD 2: Shao-Yu Lien et al., Toward Ubiquitous Massive Accesses in 3GPP Machine-to-Machine Communications, IEEE Communications Magazine, April 2011
NPD 3: Matsumoto et al., Performance Evaluation of IDMA for Small Packet Transmission, the Institute of Electronics, Information and Communication Engineers, Technical Report, RCS2011-342, March 2011
NPD 4: Li Ping et al., The OFDM-IDMA Approach to Wireless Communication Systems, IEEE Wireless Communications, June 2007
NPD 5: Ikeda et al., Standardization Activity on Cellular-Based Machine-to-Machine Communication, Panasonic Technical Journal Vol. 57, No. 1, April 2011

### SUMMARY OF INVENTION

### Technical Problem

However, the MTC management method of NPD 2 requires that individual MTC devices should make connection requests. This MTC management method therefore is unable to reduce control signals in relation with the connection requests. In the MTC management method, connection is denied if the system does not satisfy the permissible value of an MTC device. This MTC management method hence cannot satisfy the need for connecting a large number of MTC devices.

The method of NPD 3 eliminates the procedure for access requests. The base station device therefore does not know which MTC device transmits. Therefore, in the actual situation, the base station device has to perform the reception processing on the assumption of signals from MTC devices that do not transmit data. Specifically, in order to perform the reception processing for a signal actually not transmitted, the base station device has to generate a variable value for computation processing, in consideration of the component of a signal actually not transmitted. An error is then produced in an earlier stage of the iterative processing of MUD. As described above, in MUD of the base station device, unnecessary computation occurs and the reception performance may be degraded.

The present invention is made in view of the problems described above and aims to provide a wireless communication system in which a plurality of communication devices (MTC devices) performing machine communication can efficiently connect to a base station device, a base station device included in the wireless communication system, a communication device, a communication control method in the wireless communication system, the base station device and the communication devices, and a program for controlling the base station device and the communication devices.

### Solution to Problem

(1) According to an aspect of the present invention, a wireless communication system includes a plurality of communication devices each performing machine communication and a base station device performing wireless communication with the plurality of communication devices. The base station device includes a reception unit for receiving a request signal for requesting access to the base station device from, of the plurality of communication devices, each of communication devices in a first group that transmit data to the base station device using a first application data format, and an allocation unit for allocating first radio resource to a communication device operating as a gateway, of the communication devices in the first group. The communication device operating as the gateway includes a reception unit for receiving the data from each communication device not operating as the gateway in the first group, and a transmission unit for transmitting the data received from each communication device not operating as the gateway, to the base station device using the first radio resource.

(2) Preferably, each of the communication devices in the first group transmits, to the base station device, a request signal for requesting access to the base station device, using second radio resource.

(3) Preferably, the base station device determines a communication device to function as the gateway from among the communication devices in the first group, and announces information for specifying the gateway in the first group to each of communication devices other than the communication device to function as the gateway in the first group, through the base station.

(4) Preferably, the base station device allows, of the communication devices in the first group, a plurality of communication devices to function as gateways. Of a plurality of communication devices in the first group, each communication device not operating as a gateway transmits the data to the base station device through any one of the gateways.

(5) Preferably, of the plurality of communication devices, each of communication devices in a second group that transmit data to the base station device using a second application data format transmits the data to the base station device, through a communication device operating as a gateway in the first group.

(6) Preferably, the data transmitted by each of the communication devices in the first group is data based on interleave division multiple access that is generated with an interleave pattern different for each communication device.

(7) Preferably, in the first application data format, a block size of data is defined at a predetermined value.

(8) Preferably, each of the communication devices in the first group has a predetermined first function. Each of the communication devices in the second group has a predetermined second function.

### Advantageous Effects of Invention

In the configuration described above, a plurality of communication devices (MTC devices) that perform machine communication can connect to a base station device efficiently.

### BRIEF DESCRIPTION OF DRAWINGS

FIG. 1 is a diagram illustrating a schematic configuration of a wireless communication system.

FIG. 2 is a diagram illustrating an overview of a hardware configuration of an MTC device.

FIG. 3 is a diagram illustrating a typical hardware configuration of a base station device.

FIG. 4 is a diagram illustrating grouping of MTC devices.

FIG. 5 is a diagram illustrating an example of an access request acceptance segment.

FIG. 6 is a diagram illustrating a format of resource allocation information included in an access enable signal.

FIG. 7 is a diagram illustrating an example of the allocated resource.

FIG. 8 is a diagram illustrating a format of resource allocation information in a case where different MCSs and TFs are allocated to the subdivided groups.

FIG. 9 is a diagram illustrating an example of the allocated resource in a case where different MCSs and TFs are allocated to the subdivided groups.

FIG. 10 is a diagram illustrating a data format of an application used in MTC devices in group A.

FIG. 11 is a diagram illustrating a data format of an application used in MTC devices in group B.

FIG. 12 is a diagram illustrating a functional configuration of the MTC device and a functional configuration of the base station device.

FIG. 13 is a sequence chart illustrating the procedure of the processing in the wireless communication system.

FIG. 14 is a diagram illustrating an example of resource allocated to each MTC device in group A and group B.

FIG. 15 is a diagram illustrating an aspect of communication in the wireless communication system.

FIG. 16 is a diagram illustrating a schematic configuration of a wireless communication system including three groups and three gateways.

FIG. 17 is a diagram illustrating a schematic configuration of a wireless communication system in which a plurality of gateways are allocated to one group.

FIG. 18 is a diagram illustrating a schematic configuration of a wireless communication system including three groups and two gateways.

FIG. 19 is a diagram illustrating classification in LTE.

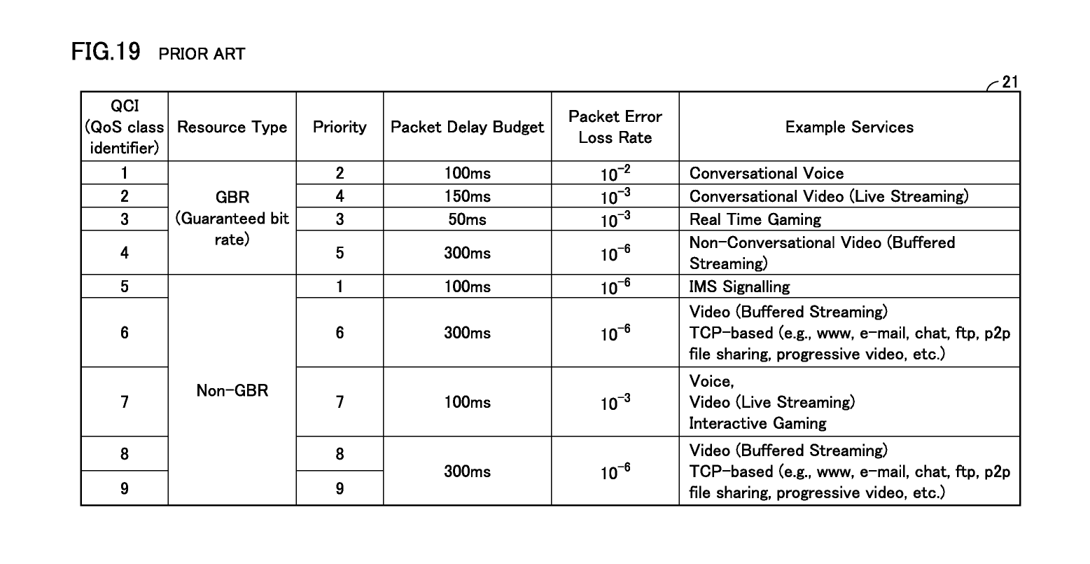

FIG. 20 is a diagram illustrating the principle of the OFDM-IDMA.

FIG. 21 is a diagram illustrating the operation of MUD.

### DESCRIPTION OF EMBODIMENTS

A communication system according to embodiments of the present invention will be described below with reference to the figures. In the following description, the same parts are denoted with the same reference signs. The designations and functions thereof are also the same. A detailed description thereof is not repeated.

<A. System Configuration>

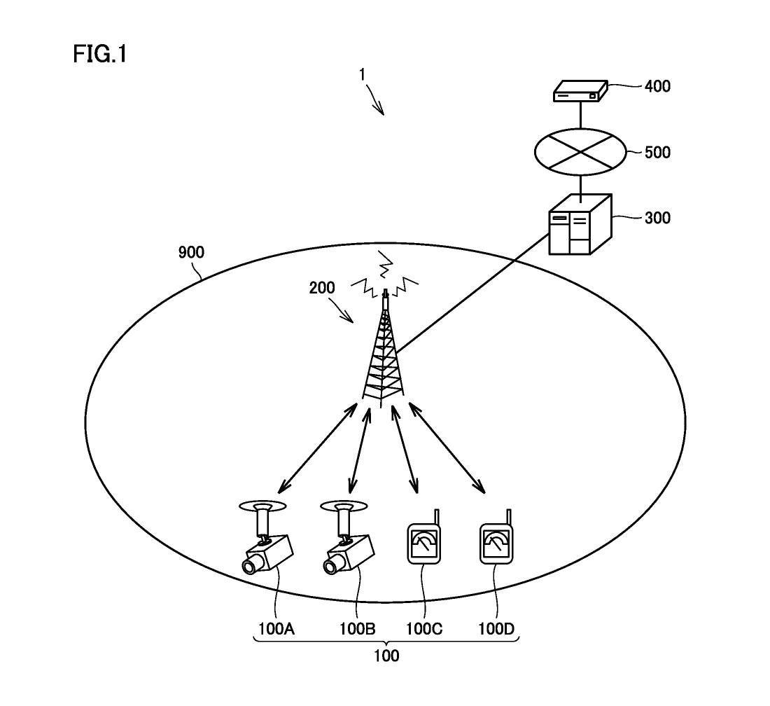

FIG. 1 is a diagram illustrating a schematic configuration of a wireless communication system 1. Referring to FIG. 1, wireless communication system 1 at least includes a plurality of MTC devices 100A to 100D, a base station device (eNB: evolved Node B) 200, an MME (Mobile Management Entity) 300, and a server device 400.

Base station device 200 forms a cell 900. MTC devices 100A to 100D reside in cell 900 in which they can communication with base station device 200. Base station device 200 is connected to be able to communicate with MME 300. MME 300 is connected to be able to communicate with server device 400 through a network (a mobile communication network and/or the Internet) 500.

MTC devices 100A to 100D are communication devices that perform machine communication. Here, the “communication device that performs machine communication” means a communication device that automatically transmits or receives data in a predetermined format (or type).

MTC devices 100A, 100B are monitoring cameras. MTC devices 100C, 100D are electric meters (smart meters (registered trademark)). MTC devices 100A to 100D each have a communication function. MTC devices 100A to 100D each communicate with base station device 200. Data (image data or measurement data) transmitted from MTC devices 100A to 100D is transmitted to server device 400 through base station device 200 and MME 300.

MME 300 mainly executes mobility management of mobile station devices (UE: User Equipment), session management, non-access layer signaling and security, alarm message transmission, and selection of a base station device matched with an alarm message.

MTC devices 100A to 100D have a function as an MTC gateway. MTC devices 100A to 100D each can configure a local network in which other MTC devices are affiliated (deployed) (hereinafter simply referred to as “local network”). For example, MTC device 100A can configure a local network having MTC device 100B affiliated therewith. Which MTC device operates as a gateway is determined by MME 300 or a device on a level higher than MME 300 (for example, server device 400). In each local network, an RAT (Radio Access Technology) appropriate for the network is selected, and MTC devices other than the MTC device operating as an MTC gateway perform communication defined in the RAT with the MTC gateway.

In the following description, a single MTC device is referred to as “MTC device 100” without differentiating MTC devices 100A to 100D, for convenience of explanation.

<B. Process Overview>

An overview of the process performed in wireless communication system 1 will be described below.

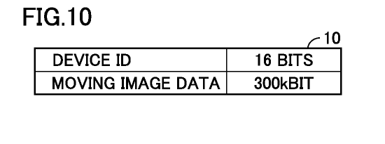

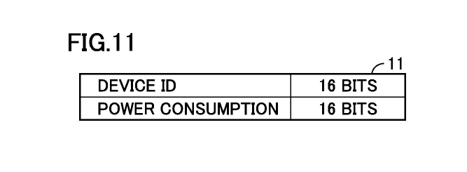

In wireless communication system 1, MTC devices 100A to 100D are grouped such that at least the block size of data transmitted by each MTC device 100A to 100D is common. That is, they are grouped according to the difference in application data format (for example, FIGS. 10 and 11) in which data is transmitted to base station device 200. Wireless communication system 1 is configured such that the traffic distribution of MTC devices is common in the same group.

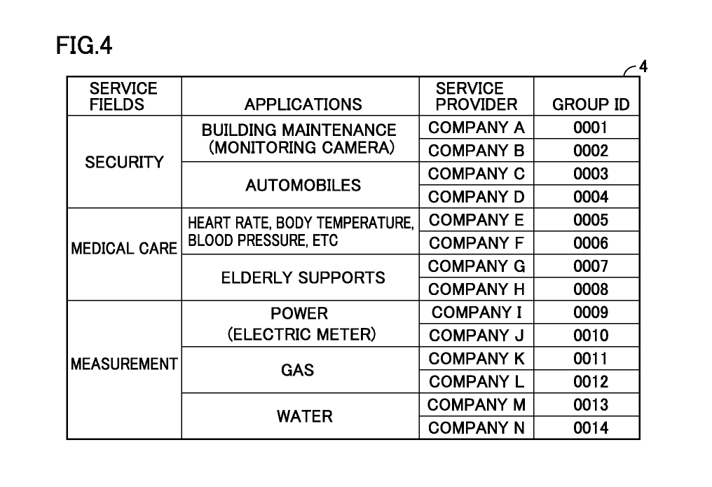

In the following, it is assumed that MTC devices 100A, 100B having a common function are classified into a group A (first group), and MTC devices 100C, 100D having a common function are classified into a group B (second group). Which MTC device belongs to which group is specified by a group ID described later (FIG. 4).

Base station device 200 or MME 300 sets an access request acceptance segment for each of a plurality of groups (group A, group B). For example, base station device 200 or MME 300 sets an access request acceptance segment PA for group A and sets an access request acceptance segment PB for group B. Wireless communication system 1 may be configured such that an entity (not shown) other than base station device 200 and MME 300 sets an access request acceptance segment.

The access request acceptance segment refers to radio resource that can be used in the uplink of wireless communication system 1. Specifically, the access request acceptance segment is configured with a plurality of successive resource blocks. For example, base station device 200 or MME 300 allocates radio resource RAα common in group A to each of MTC devices 100A, 100B in group A and allocates radio resource RBβ common in group B to each of MTC devices 100C, 100D in group B. The details of the access request acceptance segment will be described later.

Each MTC device 100 transmits an access request signal in a predetermined signal format to base station device 200 in the access request acceptance segment set for each group. Base station device 200 transmits an access enable signal corresponding to the access request signal collectively to MTC devices 100. Specifically, base station device 200 allocates radio resource RAβ common in group A to each of MTC devices 100A, 100B in group A and allocates radio resource RBβ common in group B to each of MTC devices 100C, 100D in group B.

Base station device 200 determines an MTC device to function as an MTC gateway from among MTC devices 100A, 100B in group A. Base station device 200 determines an MTC device to function as an MTC gateway from among MTC devices 100C, 100D in group B.

Base station device 200 transmits an access enable signal (control information C1) including resource allocation information indicating allocation of radio resource RAβ and gateway allocation information for specifying (designating) the MTC gateway in group A, to each of MTC devices 100A, 100B in group A. Base station device 200 also transmits an access enable signal (control information C2) including resource allocation information indicating allocation of radio resource RBβ and gateway allocation information for specifying the MTC gateway in group B, to each of MTC devices 100C, 100D in group B.

The MTC device designated to operate as an MTC gateway in the gateway allocation information (for example, MTC device 100B in group A, MTC device 100C in group B) not only operates as a normal MTC device but also operates as an MTC gateway.

The MTC device not operating as an MTC gateway in each group (for example, MTC devices 100A, 100D) transmits data to the MTC gateway in the group that the device itself belongs to, in a predetermined signal format, using the radio resource defined in the local network (radio resource designated by the MTC gateway). For example, MTC device 100A transmits video data to MTC device B.

The MTC device operating as an MTC gateway in each group receives the data from the MTC device not operating as an MTC gateway in the same group. For example, MTC device 100B receives video data from MTC device 100A.

The MTC device operating as an MTC gateway in each group transmits the data received from the MTC device not operating as an MTC gateway and data acquired by the device itself to base station device 200 using a predetermined signal format, in accordance with the resource allocation information included in the access enable signal. Specifically, the MTC device (for example, MTC device 100B) functioning as a gateway in group A transmits video data to base station device 200 using radio resource RAβ. The MTC device (for example, MTC device 100C) functioning as a gateway in group B transmits measurement data to base station device 200 using radio resource RBβ.

As described above, in wireless communication system 1, a plurality of MTC devices 100 are grouped so that access request, resource allocation, and data transmission are collectively performed, thereby enabling more MTC devices 100 to connect to the network (base station device 200, MME 300, server device 400) efficiently.

One of MTC devices in each group functions as a gateway, so that control information from the network side can be transmitted, group by group, in allocation of radio resource. By allowing one of MTC devices in each group to function as a gateway, the load (traffic) in the network (base station device 200, MME 300, server device 400) can be spread compared with a case without functioning as a gateway. Accordingly, by allowing one of MTC devices in each group to function as a gateway, more MTC devices 100 can connect to the network (base station device 200, MME 300, server device 400) efficiently, compared with a case without functioning as a gateway.

A configuration in which base station device 200 sets an access request acceptance segment for each of a plurality of groups will be described below, by way of example, for convenience of explanation.

<C. Hardware Configuration>

(c1. MTC Device 100)

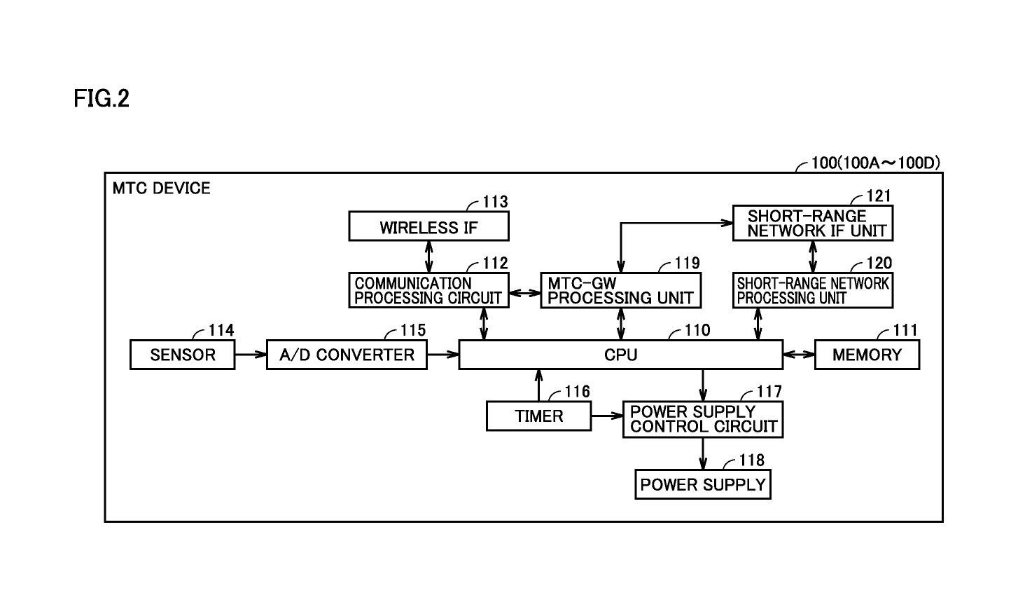

FIG. 2 is a diagram illustrating an overview of a hardware configuration of MTC device 100. Referring to FIG. 2, MTC device 100 includes a CPU (Central Processing Unit) 110, a memory 111, a communication processing circuit 112, a wireless IF 113, a sensor 114, an A/D (Analog to Digital) converter 115, a timer 116, a power supply control circuit 117, a power supply 118, an MTC-GW (Gateway) processing unit 119, a short-range network processing unit 120, and a short-range network IF unit 121.

When a start instruction signal is input from power supply control circuit 117, CPU 110 reads out a program stored in memory 111. CPU 110 runs the read program to control the entire operation of MTC device 100. CPU 110 reads out an equipment identifier (device ID) and an MTC group identifier (group ID) stored in advance from memory 111. CPU 110 extracts information corresponding to the access request acceptance segment corresponding to the group ID from the received information from base station device 200 that is input from communication processing circuit 112. CPU 110 stores the extracted information corresponding to the access request acceptance segment into memory 111. CPU 110 generates schedule information corresponding to the access request acceptance segment and sets the same in power supply control circuit 117.

CPU 110 temporarily stores digital data input from A/D converter 115 into memory 111. CPU 110 generates an access request signal corresponding to the access request acceptance segment. CPU 110 outputs the generated access request signal, as a signal to be transmitted to base station device 200, to communication processing circuit 112. CPU 110 generates a signal for transmitting the digital data temporarily stored in memory 111 to base station device 200, in response to the access enable signal from the base station that is input from communication processing circuit 112. CPU 110 outputs the generated signal to communication processing circuit 112. When a stop instruction signal is input from power supply control circuit 117, CPU 110 stops the operation of the running program thereby to stop the operation of units other than timer 116 and power supply control circuit 117.

Communication processing circuit 112 processes a signal in a base frequency band input from wireless IF 113 (received signal) to generate an information signal sequence or a control information sequence. Communication processing circuit 112 outputs the generated sequence to CPU 110. Communication processing circuit 112 outputs the signal input from CPU 110, as a signal in a base frequency band to be transmitted to base station device 200, to wireless IF 113.

Wireless IF 113 down-converts the signal received via radio waves from base station device 200 to generate a signal in a base frequency band. Wireless IF 113 outputs the generated signal in a base frequency band to communication processing circuit 112. Wireless IF 113 up-converts the signal in a base frequency band input from communication processing circuit 112 to generate a signal in a radio frequency band. Wireless IF 113 outputs the generated signal in a radio frequency region, with power amplified, to base station device 200 via radio waves.

Sensor 114 senses analog data representing the surrounding environment of MTC device 100. Sensor 114 is, for example, a camera capturing an image or an electric power sensor including a voltmeter and an ammeter for measuring electric power. Sensor 114 outputs the sensed analog data to A/D converter 115.

A/D converter 115 performs A/D conversion of the analog data input from sensor 114 to generate digital data. A/D converter 115 outputs the generated digital data to CPU 110.

Timer 116 sequentially measures the present time and outputs the measured time information to CPU 110 and power supply control circuit 117.

In power supply control circuit 117, scheduling information is preset, which represents information about the start time to start power supply 118 and the stop time to stop power supply 118. It is noted that “stop” means a state in which timer 116 and power supply control circuit 117 operate while the other functional units stop. Power supply control circuit 117 generates a start instruction to start when the time information input from timer 116 reaches the start time represented by the scheduling information corresponding to the time information. Power supply control circuit 117 generates a stop instruction signal to stop when the time information input from timer 116 reaches the stop time represented by the scheduling information corresponding to the time information. Power supply control circuit 117 outputs the generated start instruction signal or stop instruction signal to CPU 110 and power supply 118.

Power supply 118 supplies power to each unit in MTC device 100 when a start instruction signal is input from power supply control circuit 117. Power supply 118 stops supply of power supply 118 to each unit other than timer 116 and power supply control circuit 117 after a stop instruction signal is input from power supply control circuit 117 and the operation of CPU 110 stops.

MTC-GW processing unit 119 requests MTC gateway information from CPU 110. If MTC gateway information is obtained, MTC-GW processing unit 119 generates an MTC terminal registration request signal as an MTC device that communicates in a short-range communication network as an MTC gateway affiliate. MTC-GW processing unit 119 outputs the MTC terminal registration request signal to short-range network processing unit 120.

If a reception signal (registration permitted or denied) from the MTC gateway is obtained from short-range network processing unit 120, MTC-GW processing unit 119 outputs the reception signal to CPU 110. If no signal is received after elapse of a certain time, MTC-GW processing unit 119 generates a registration-denied signal. MTC-GW processing unit 119 outputs the generated signal to CPU 110.

If MTC gateway allocation information is obtained, MTC-GW processing unit 119 waits for a registration request signal to be sent from another MTC device from short-range network processing unit 120, as an MTC device that communicates as an MTC gateway with another MTC device in the short-range communication network. If a registration request signal is obtained, MTC-GW processing unit 119 outputs the registration request signal to CPU 110. If a registration permitted/denied signal from CPU 110 is received, MTC-GW processing unit 119 outputs the received signal to short-range network processing unit 120.

Short-range network processing unit 120 converts a reception signal in a radio frequency band input from short-range network IF unit 121 into a reception signal in a base frequency band. Short-range network processing unit 120 outputs the converted reception signal to CPU 110. Short-range network processing unit 120 receives a transmission signal from CPU 110. Short-range network processing unit 120 converts the input transmission signal in the base frequency band into a transmission signal in a radio frequency band. Short-range network processing unit 120 outputs the converted transmission signal in a radio frequency band to short-range network IF unit 121.

Short-range network IF unit 121 transmits the transmission signal in a radio frequency band input from short-range network processing unit 120 to another MTC device or the MTC gateway. Short-range network IF unit 121 receives a reception signal in a radio frequency band from an MTC device or the MTC gateway. Short-range network IF unit 121 outputs the received reception signal in a radio frequency band to short-range network processing unit 120.

The processing in MTC device 100 is implemented by hardware and software executed by CPU 110. Such software may be stored in memory 111 in advance. The software may be stored in memory cards or other storage media and distributed as program products. Otherwise, the software may be provided as downloadable program products by an information provider connected to the Internet. Such software is read out from the storage medium by an IC card reader/writer or other reading devices or downloaded via wireless IF 113 and then temporarily stored into memory 111. The software is read out from memory 111 by CPU 110 and stored in the form of an executable program into memory 111. CPU 110 executes the program.

Each component included in MTC device 100 shown in the figure is the general one. It can be said that the essential part of the present invention is the software stored in memory 111, a memory card, or other storage media or software downloadable via a network.

The recording medium is not limited to a DVD-ROM, a CD-ROM, an FD, and a hard disk but may be a medium that fixedly carries the program, such as a magnetic tape, a cassette tape, an optical disk, an optical card, and a semiconductor memory such as a mask ROM, an EPROM, an EEPROM, and a flash ROM. The recording medium is a non-transitory medium having the program or other data readable by a computer. The program referred to here includes not only a program directly executable by a CPU but also a program in a source program format, a compressed program, and an encrypted program.

(c2. Base Station Device 200)

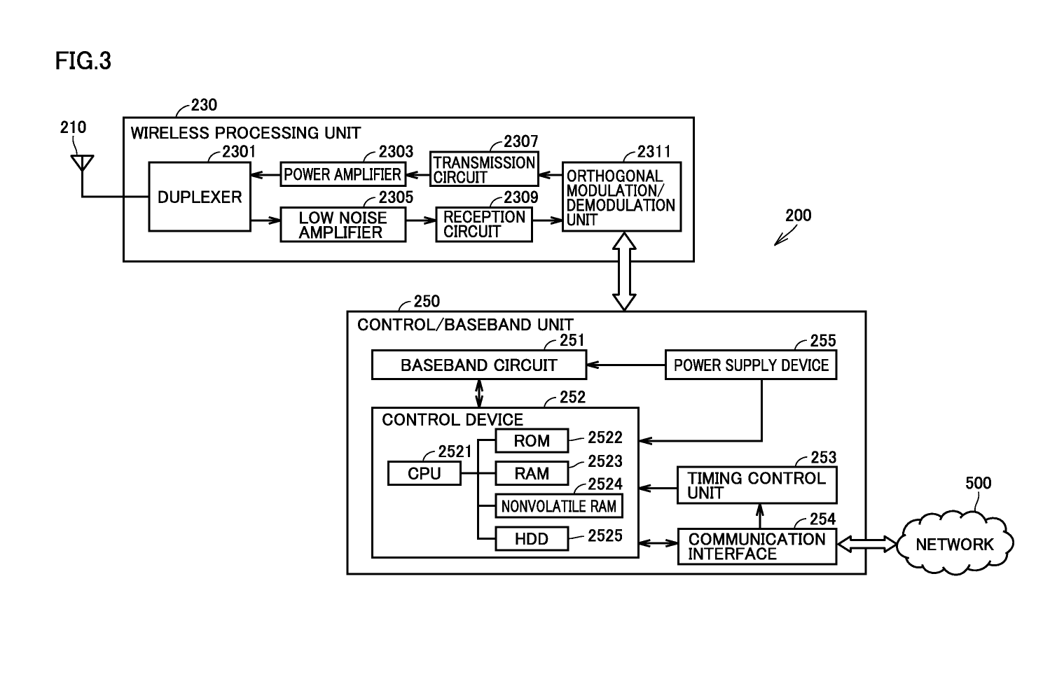

FIG. 3 is a diagram illustrating a typical hardware configuration of base station device 200. Referring to FIG. 3, base station device 200 includes an antenna 210, a wireless processing unit 230, and a control/baseband unit 250.

Wireless processing unit 230 includes a duplexer 2301, a power amplifier 2303, a low noise amplifier 2305, a transmission circuit 2307, a reception circuit 2309, and an orthogonal modulation/demodulation unit 2311. Control/baseband unit 250 includes a baseband circuit 251, a control device 252, a power supply device 255, a timing control unit 253, and a communication interface 254. Control device 252 includes a CPU 2521, a ROM 2522, a RAM 2523, a nonvolatile memory 2524, and an HDD (Hard Disk Drive) 2525.

Orthogonal modulation/demodulation unit 2311 orthogonally modulates/demodulates an OFDM (Orthogonal Frequency Division Multiplexing) signal processed by baseband circuit 251 for conversion into an analog signal (RF (Radio Frequency) signal). Transmission circuit 2307 converts the RF signal generated by orthogonal modulation/demodulation unit 2311 into a frequency to be sent as a radio wave. Reception circuit 2309 converts the received radio wave into a frequency to be processed by orthogonal modulation/demodulation unit 2311.

Power amplifier 2303 amplifies power of the RF signal generated by transmission circuit 2307 for transmission from antenna 210. Low noise amplifier 2305 amplifies a weak radio wave received by antenna 210 and passes the amplified radio wave to reception circuit 2309.

Control device 252 performs control of the entire base station device 200 and protocol or control monitoring for call control. Timing control unit 253 generates a variety of clocks for use in the inside of base station device 200, based on a reference clock extracted from, for example, a transmission path.

Communication interface 254 connects a transmission path such as Ethernet (registered trademark) and processes a protocol such as IPsec (Security Architecture for Internet Protocol) and IPv6 (Internet Protocol Version 6) to exchange IP packets.

Baseband circuit 251 performs conversion (modulation/demodulation) of an IP packet exchanged using communication interface 254 and an OFDM signal (baseband signal) carried on a radio wave. The baseband signal is exchanged with wireless processing unit 230.

Power supply device 255 converts the voltage supplied to base station device 200 into a voltage used in the inside of base station device 200.

The processing in base station device 200 is implemented by hardware and software executed by CPU 2521. Such software may be stored in, for example, HDD 2525 in advance. The software may be stored in memory cards (not shown) or other storage media and distributed as program products. Otherwise, the software may be provided as downloadable program products by an information provider connected to the Internet. Such software is read out from the storage medium by an IC card reader/writer or other reading devices or downloaded via communication interface 254 and then temporarily stored into HDD 2525. The software is read out from HDD 2525 by CPU 2521 and then stored in the form of an executable program into nonvolatile memory 2524. CPU 2521 executes the program.

Each component included in base station device 200 shown in the figure is the general one. It can be said that the essential part of the present invention is the software stored in HDD 2525, nonvolatile memory 2524, a memory card, or other storage medium or software downloadable via a network. The operation of the hardware of base station device 200 is well known and a detailed description thereof is not repeated.

The recording medium is not limited to a DVD-ROM, a CD-ROM, an FD (Flexible Disk), and a hard disk but may be a medium that fixedly carries the program, such as a magnetic tape, a cassette tape, an optical disk (MO (Magnetic Optical Disc)/MD (Mini Disc)/DVD (Digital Versatile Disc)), an optical card, and a semiconductor memory such as a mask ROM, an EPROM (Electronically Programmable Read-Only Memory), an EEPROM (Electronically Erasable Programmable Read-Only Memory), and a flash ROM. The recording medium is a computer-readable non-transitory medium. The program referred to here includes not only a program directly executable by a CPU but also a program in a source program format, a compressed program, and an encrypted program.

<D. Details of Processing>

The details of the processing performed in wireless communication system 1 will now be described.

FIG. 4 is a diagram illustrating grouping of MTC devices 100. As described above, MTC devices having a common function (characteristic) are classified into the same group.

Referring to FIG. 4, in a data table 4, service fields, applications, and service providers are associated with group IDs representing groups. Data table 4 is stored in base station device 200 or MME 300. Examples of the service fields include security, medical care, and measurement fields. Examples of the applications include applications used in the fields of building maintenance, automobiles, human body status measurement (heart rate, body temperature, blood pressure, etc.), elderly supports, electric power, gas, water, and the like.

For example, in the application for building maintenance with a monitoring camera having a group ID “0001” (corresponding to “group A”), video of the monitoring camera (MTC devices 100A, 100B) is successively transmitted at 300 kbps. For example, MTC devices 100A and 100B are monitoring cameras of Company A. MTC devices 100A, 100B transmit a data block of 300 kbit once a second to base station device 200 in order to enhance the communication efficiency while permitting a delay.

In the application of power consumption measurement with an electric meter having a group ID “0009” (corresponding to “group B”), the electric meter (MTC devices 100C, 100D) transmits a data block of 32 bits once an hour. For example, MTC devices 100C and 100D are monitoring cameras of Company I.

Each MTC device 100 receives allocation of a group ID from MME 300 through position registration processing. The communication for the position registration is not bound to the access request acceptance segment below. Alternatively, an ID set in advance in a memory (for example, a ROM (Read Only Memory) or a USIM (Universal Subscriber Identification Module)) may be used as a group ID.

Base station device 200 sets an access request acceptance segment for each group. Base station device 200 announces the set access request acceptance segment as notification information to each MTC device 100. In doing so, terminal devices (MTC devices and non-MTC devices) in wireless communication system 1 may be configured such that MTC device 100 in each group receives only the information block including information representing the device's own group and a not-shown non-MTC device (a user terminal device other than an MTC device) does not receive the information. Alternatively, information representing the group may be announced to MTC device 100 during position registration.

Each MTC device 100 transmits an access request signal to base station device 200 in a format designated, for example, by the notification information, based on the group ID, in the access request acceptance segment allocated to the device's own group.

Base station device 200 identifies which MTC device 100 has transmitted the access request signal, based on the received signal. By using a signal with high orthogonality as the access request signal, base station device 200 can receive access request signals simultaneously from a plurality of MTC devices 100.

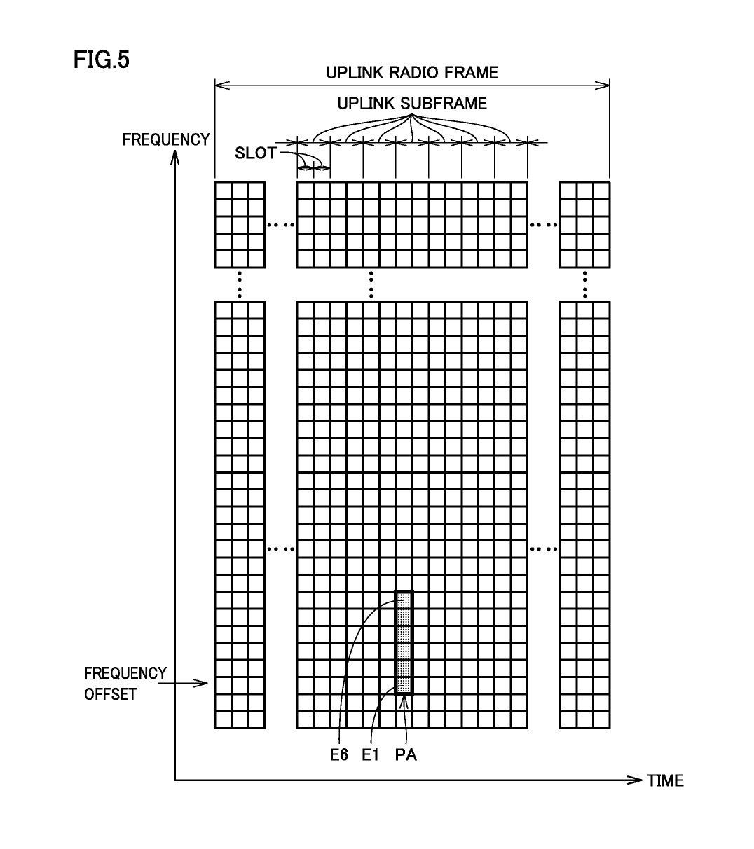

FIG. 5 is a diagram illustrating an example of the access request acceptance segment. Specifically, FIG. 5 illustrates access request acceptance segment PA allocated to group A. Referring to FIG. 5, MTC devices 100A, 100B in group A transmit an access request to base station device 200 in the allocated access request acceptance segment PA. Access request acceptance segment PA is configured with six resource blocks in succession in the frequency direction, in a predetermined subframe (uplink subframe) in one frame. Specifically, access request acceptance segment PA is a segment defined by a resource block E1 and a resource block E6.

In LTE, each of a plurality of uplink subframes is configured with two slots (uplink slots) adjacent in the time axis direction. Each slot includes a plurality of resource blocks in the frequency axis direction. Each resource block is configured with a region of 180 kHz×0.5 msec. Each resource block is configured with a plurality of resource elements (12 in the frequency axis direction and seven in the time axis direction, in total, 84 resource elements).

In this manner, MTC devices 100A, 100B in group A each transmit data to base station device 200, using six resource blocks (radio resource) in succession in the frequency direction, in a predetermined subframe (uplink subframe) in one frame.

MTC devices 100A, 100B determine access request acceptance segment PA, based on the number of the frame, the number of the uplink subframe, and the frequency offset corresponding to group A. Since the number of the frame is repeated every 10 seconds or so, another parameter is necessary in order to increase the interval between segments. MTC devices 100A, 100B generate a sequence using a parameter provided by a root sequence index and performs shift processing corresponding to the device ID.

Base station device 200 receives access request signals transmitted from MTC devices 100. Base station device 200 confirms that the received access request signals are the access request signals from devices in the designated group. If the number of access request signals is equal to or smaller than a permissible number, base station device 200 transmits a control signal including resource allocation information (access enable, scheduling) to these MTC devices 100.

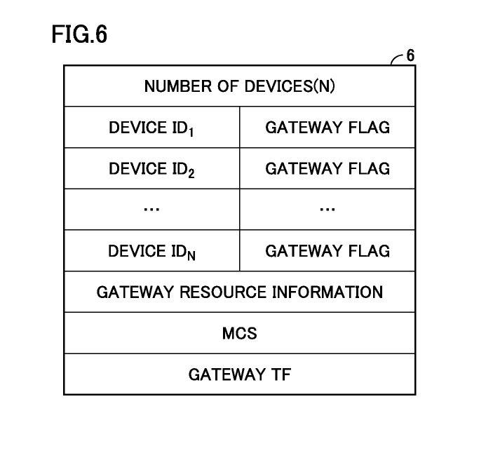

FIG. 6 is a diagram illustrating a format of the resource allocation information included in the access enable signal (control information). Referring to FIG. 6, with a format 6 of the resource allocation information, allocation to a plurality of devices can be announced using single resource allocation information. The number of devices N represents the number of MTC devices 100 to which allocation is performed. The device ID (ID₁ to ID_{N}) indicates the ID of each MTC device 100. The gateway resource information field includes information of the start position and the length of a resource block in the resource allocated. The gateway flag designates the MTC device designated as an MTC gateway. Examples of the criteria for being designated include that the MTC device has the best communication quality. MCS (Modulation and Coding Scheme) indicates a combination of a modulation scheme and a code rate in transmission. Gateway TF (Transport Format) indicates a transmission format.

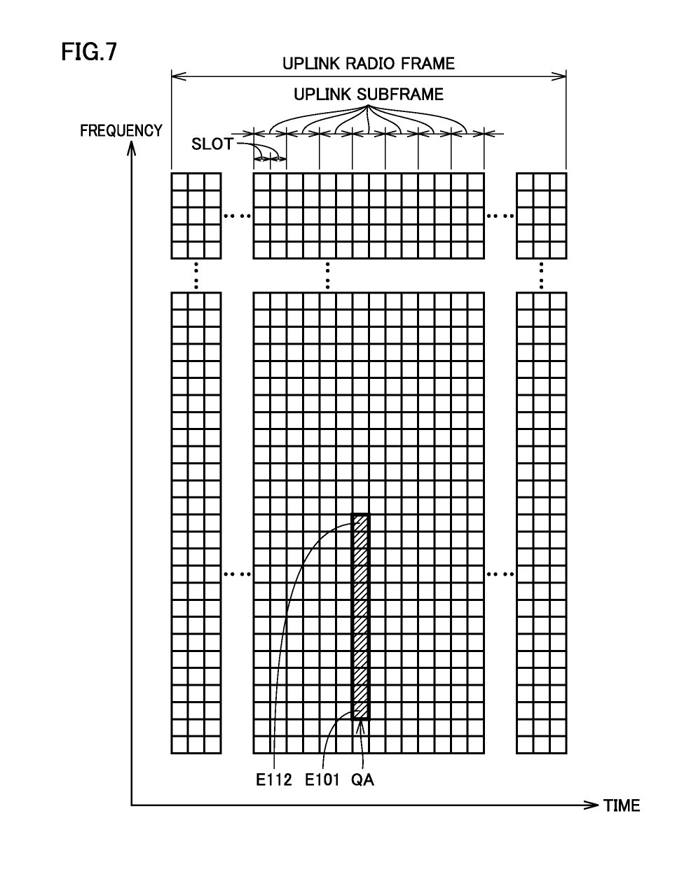

FIG. 7 is a diagram illustrating an example of the allocated resource. Referring to FIG. 7, of N MTC devices 100 designated by device IDs, MTC device 100 designated by the gateway flag uses the resource block indicated by the resource information field. MTC device 100 to which resource is allocated uses the designated MCS and TF. That is, MTC device 100 to which resource is allocated transmits data (for example, video data) to base station device 200 using the designated MCS and TF in a segment QA.

For example, the MTC gateway (for example, MTC 100B) in group A transmits data to base station device 200 in the allocated segment QA. The segment QA is configured with 12 resource blocks in succession in the frequency direction, in a predetermined uplink subframe in one frame. Specifically, the segment QA is a segment defined by a resource block E101 and a resource block E112. In this case, MTC devices 100A, 100B in group A each transmit video data to base station device 200, using 12 resource blocks (radio resource) in succession in the frequency direction, in a predetermined uplink subframe in one frame.

FIG. 6 described above illustrates a configuration in which one MTC gateway is present in one group (for example, group A). However, the embodiment is not limited thereto. For example, wireless communication system 1 may be configured such that one group is subdivided into a plurality of groups (hereinafter referred to as “subgroups”) according to the distance from base station device 200 and that an MTC gateway is present in each of the subdivided groups. That is, wireless communication system 1 may be configured such that different MCSs and TFs are allocated to the subdivided groups.

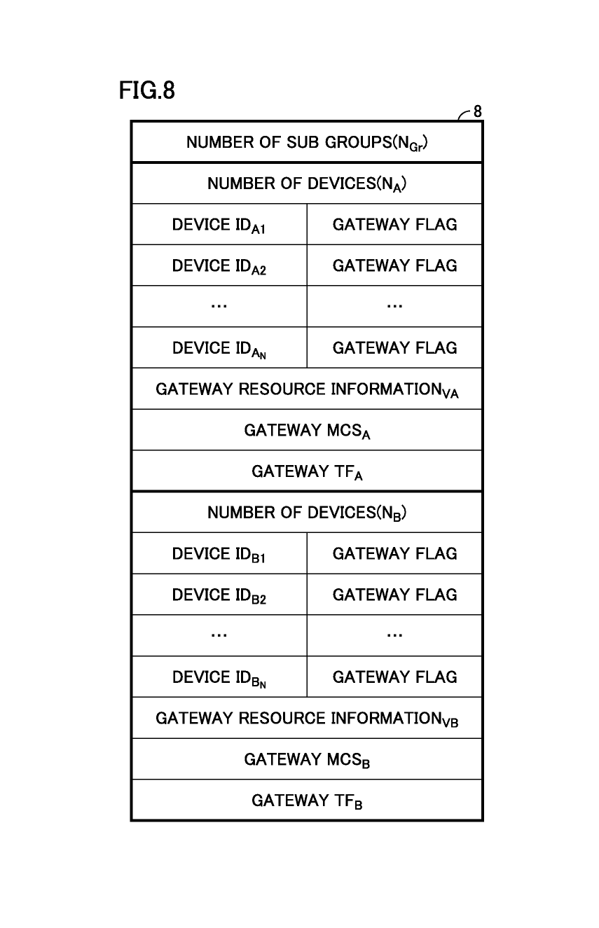

FIG. 8 is a diagram illustrating a format 8 of the resource allocation information in a case where different MCSs and TFs are allocated to the subdivided groups. That is, FIG. 8 depicts format 8 of the resource allocation information for an MTC gateway in a case where one MTC device operates as an MTC gateway in each of a plurality of subgroups formed by subdividing one group.

Referring to FIG. 8, in format 8, one group (for example, group A) is subdivided into two subgroups. Of NA MTC devices 100 specified by device ID_{A1} to ID_{AN} in format 8, an MTC device 100 (that is, MTC gateway) designated by the gateway flag uses a resource block designated by gateway resource information VA. MTC device 100 having resource allocated transmits data to base station device 200 using the designated gateway MCS_{A} and gateway TF_{A}.

Of NB MTC devices 100 specified by device ID_{B1} to ID_{BN}, an MTC device 100 (that is, MTC gateway) designated by the gateway flag uses a resource block designated by gateway resource information _{VB}. MTC device 100 having resource allocated transmits data to base station device 200 using the designated gateway MCS_{B} and gateway TF_{B}.

That is, one designated MTC device 100 of NA MTC devices 100 transmits data (for example, video data) to base station device 200 using gateway MCS_{A} and gateway TF_{A}, in the allocated radio resource (for example, segment QB described later). One designated MTC device 100 of NB MTC devices 100 transmits data (for example, video data) to base station device 200 using gateway MCS_{B} and gateway TF_{B}, in the radio resource separately allocated (segment QC described later).

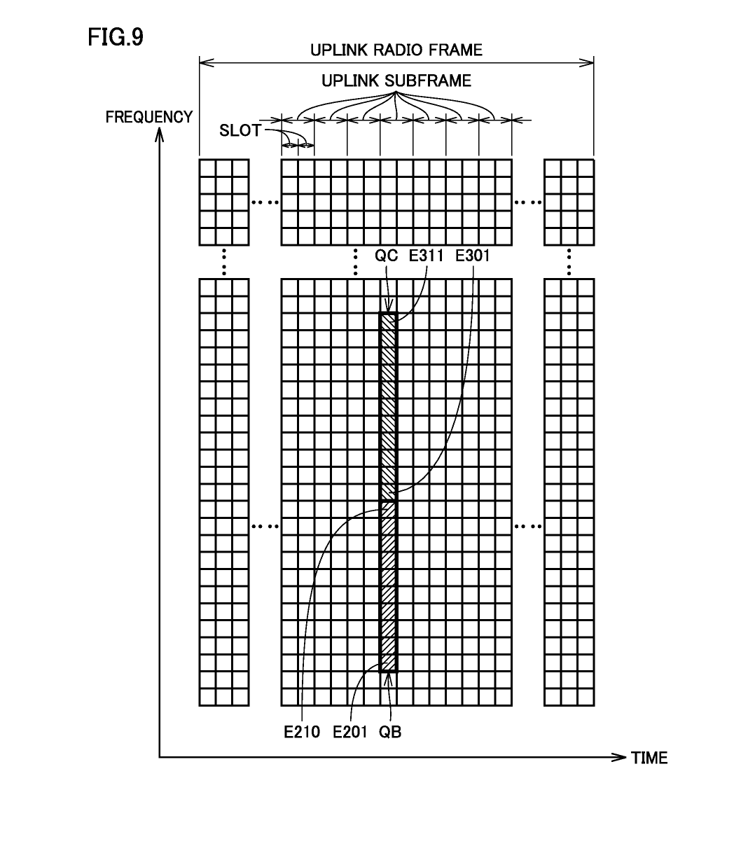

FIG. 9 is a diagram illustrating an example of the allocated resource in a case where different MCSs and TFs are allocated to the subdivided groups. Referring to FIG. 9, for example, one designated MTC device 100 of NA MTC devices 100 transmits data to base station device 200 in the allocated segment QB. The segment QB is configured with 10 resource blocks in succession in the frequency direction, in a predetermined uplink subframe in one frame. Specifically, the segment QB is a segment defined by a resource block E201 and a resource block E210.

One designated MTC device 100 of NB MTC devices 100 transmits data to base station device 200 in the allocated segment QC. The segment QC is configured with 11 resource blocks in succession in the frequency direction, in a predetermined uplink subframe in one frame. Specifically, the segment QC is a segment defined by a resource block E301 and a resource block E311. Resource block E301 is adjacent to resource block E210.

FIG. 10 is a diagram illustrating a data format of an application used in MTC devices 100A, 100B (monitoring cameras) in group A. Referring to FIG. 10, MTC devices 100A, 100B transmit the captured video data to server device 400 through base station device 200 and MME 300, using a data format 10 for transmitting moving image data obtained by image capturing at 300 kbit.

FIG. 11 is a diagram illustrating a data format of an application used in MTC devices 100C, 100D (electric meters) in group B. Referring to FIG. 11, MTC devices 100C, 100D transmit power consumption data obtained through measurement to server device 400 through base station device 200 and MME 300, using a data format 11 for transmission at 16 bits.

The data transmitted from an MTC device may include, in addition to the application data shown in FIG. 10 and FIG. 11, information such as an IP header including the preset device's own IP address and the IP address of the destination MTC server, and a TCP or UDP header including a port number.

When base station device 200 simultaneously allocates transmission for a plurality of MTC devices 100 in the same group, the lengths of signals simultaneously transmitted from MTC devices 100 are standardized. Allocating transmission data of different data lengths to a common TF is inefficient because padding is required. However, in this case, signals having a standardized data length are associated with a common TF, thereby enabling efficient transmission. Each MTC device generates a signal for transmission, using the device ID uniquely allocated to MTC device 100.

In wireless communication system 1, since a plurality of MTC devices 100 use common radio resource, the signals may collide and interfere with each other. There are some possible methods by which base station device 200 extracts data transmitted from each MTC device 100 while suppressing interference of signals from other MTC devices 100. In wireless communication system 1, the IDMA system described above is used as a method for extracting data.

According to NPD 3 above in connection with the IDMA system, a common MCS alone is announced to all the terminals in a cell, without performing scheduling, whereas in wireless communication system 1, scheduling of MTC devices 100 is performed in response to access request signals. The control information required for scheduling, however, is significantly small compared with the conventional method in which scheduling is performed for MTC devices one by one, because the scheduling can be sent collectively to a plurality of MTC devices 100.

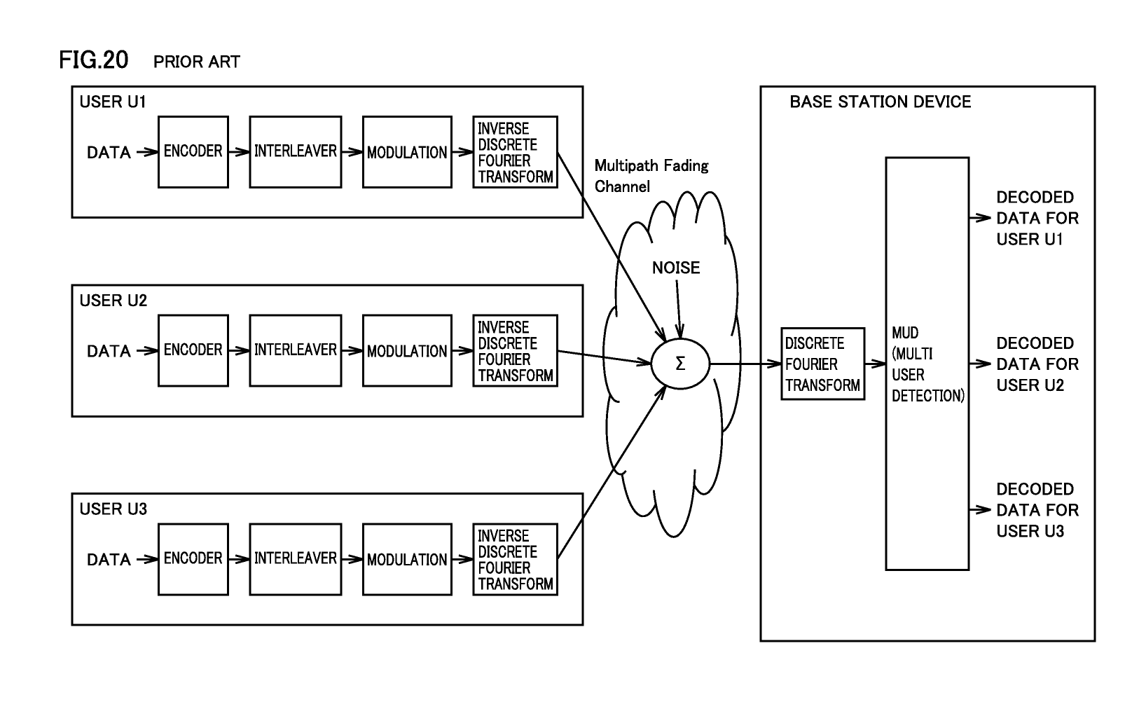

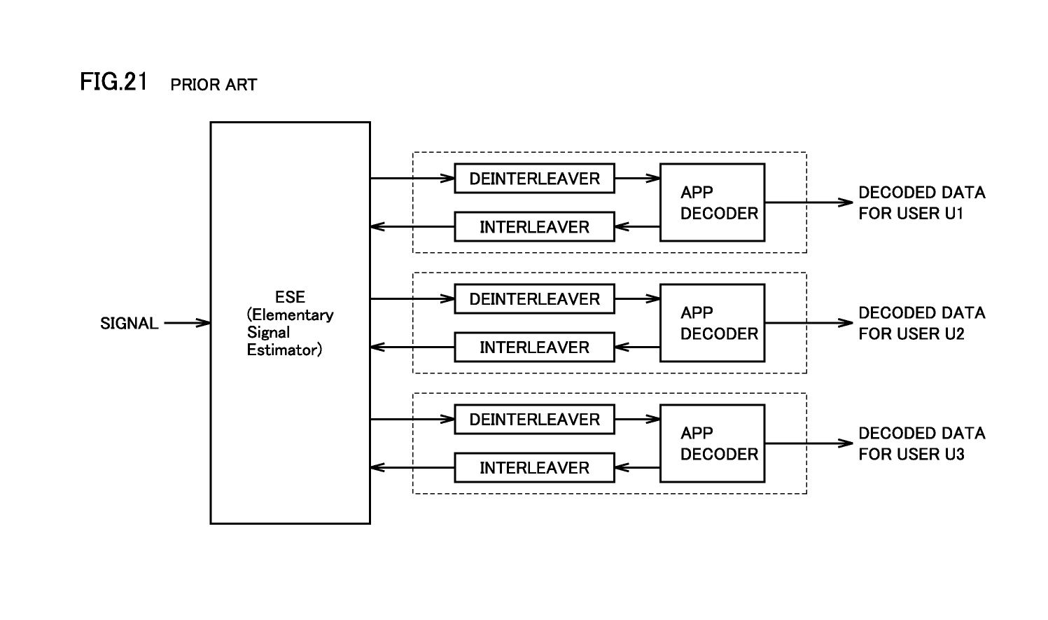

For the processing of receiving and demodulating an IDMA signal, the method described in conjunction with FIG. 20 and FIG. 21 is used. A repeated description is not given here.

When the iterative processing by MUD as described above for enhancing the accuracy of signal estimation is performed, it is important that data of MTC devices 100 is transmitted using common MCS and TF. If MTC devices 100 transmit data to base station device 200 using different MCSs and/or different TFs, the MUD processing in base station device 200 varies among MTC devices 100, and the allocation of the processing becomes complicated. With the standardized MCS and TF, base station device 200 easily performs the iterative processing of decoding the signals sent from MTC devices 100, in parallel. That is, in a case where MCSs and TFs cannot be standardized, the length of the interleaver in FIG. 21, the processing volume of the decoder, and the storage capacity vary, and in addition, the processing delay also varies. With the standardized MCS and TF, a common configuration of the deinterleaver, the APP decoder, and the interleaver for each user can be used, and it is only necessary to change interleave patterns. With the standardized MCS and TF, the processing delays become uniform and base station device 200 easily parallelizes the decoding processing. Furthermore, with the standardized MCS and TF, base station device 200 no longer has to perform the processing such as quality measurement for determining the MCS and the TF, and notification of data volume.

<E. Functional Configuration>

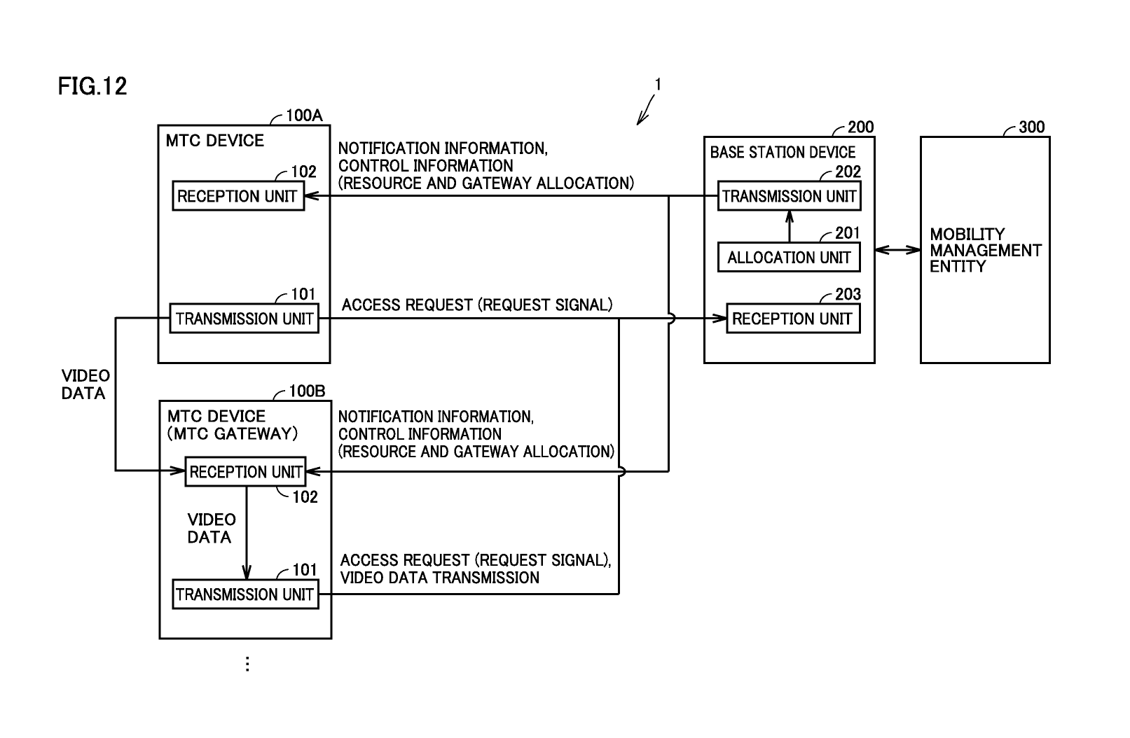

FIG. 12 is a diagram illustrating a functional configuration of MTC device 100 and a functional configuration of base station device 200. In FIG. 12, of MTC devices, two MTC devices 100A, B in group A are illustrated for the sake of convenience. Referring to FIG. 12, MTC device 100 includes a transmission unit 101 and a reception unit 102. Base station device 200 includes an allocation unit 201, a transmission unit 202, and a reception unit 203.

(1) Allocation unit 201 of base station device 200 allocates radio resource RAα common in group A, to each of MTC devices 100A, 100B in group A that transmits data to base station device 200 using a first application data format, among a plurality of MTC devices 100. Allocation unit 201 further allocates radio resource RBα common in group B, to each of MTC devices 100C, 100D (not shown) in group B that transmits data to base station device 200 using a second application data format, among a plurality of MTC devices 100.

Each transmission unit 101 in MTC devices 100A, 100B in group A transmits, to base station device 200, a request signal for requesting access to base station device 200, using radio resource RAα. Each transmission unit 101 in MTC devices 100C, 100D in group B transmits, to base station device 200, a request signal for requesting access to base station device 200, using radio resource RBα.

Reception unit 203 of base station device 200 receives a request signal from each of MTC devices 100A, 100B in group A. Reception unit 203 also receives a request signal from each of MTC devices 100C, 100D in group B.

Allocation unit 201 allocates radio resource RAβ to the MTC device (in FIG. 12, MTC device 100B) allowed to operate as an MTC gateway, of MTC devices 100A, 100B that have transmitted a request signal. Allocation unit 201 further allocates radio resource RBβ to the MTC device (for example, MTC device 100C) allowed to operate as an MTC gateway, of MTC devices 100C, 100D that have transmitted a request signal.

Transmission unit 202 of base station device 200 transmits an access enable signal (control information C1) including resource allocation information indicating allocation of radio resource RAβ and gateway allocation information for specifying (designating) an MTC gateway in group A, to each of MTC devices 100A, 100B communication devices that has transmitted a request signal. Transmission unit 202 also transmits an access enable signal (control information C2) including allocation information indicating allocation of radio resource RBβ and gateway allocation information for specifying an MTC gateway in group B, to each of MTC devices 100C, 100D that has transmitted a request signal.

Each reception unit 102 of MTC devices 100A, 100B in group A receives the access enable signal (control information C1) including resource allocation information indicating allocation of radio resource RAβ and gateway allocation information from base station device 200. On the other hand, each reception unit 102 of MTC devices 100C, 100D in group B receives the access enable signal (control information C2) including resource allocation information indicating allocation of radio resource RBβ and gateway allocation information from base station device 200.

Transmission unit 101 of MTC device 100A in group A transmits target data (video data captured by the monitoring camera) to MTC device 100B operating as an MTC gateway, using the radio resource designated in the local network of group A. Transmission unit 101 of MTC device 100B in group A transmits target data (video data captured by the monitoring camera) to base station device 200, using radio resource RAβ.

Transmission unit 101 of MTC device 100D in group B transmits target data (power consumption measured by the electric meter) to MTC device 100C operating as an MTC gateway, using the radio resource designated in the local network of group B. Transmission unit 101 of MTC device 100C in group B transmits target data (power consumption measured by the electric meter) to base station device 200, using radio resource RBβ.

(2) A common group ID is set for each of MTC devices 100A, 100B in group A. A common group ID, different from that of group A, is set for each of MTC devices 100C, 100D in group B as well.

Allocation unit 201 of base station device 200 allocates radio resource RAα common in group A, to each of MTC devices 100A, 100B having the group ID of group A. Allocation unit 201 also allocates radio resource RBα common in group B, to each of MTC devices 100C, 100D having the group ID of group B.

(3) The access enable signal (control information C1) including allocation information indicating allocation of radio resource RAβ and the access enable signal (control information C2) including allocation information indicating allocation of radio resource RBβ include a plurality of device IDs for identifying MTC devices 100 (for example, FIG. 6).

The access enable signal (control information C1) including allocation information indicating allocation of radio resource RAβ further includes a signal format (MCS and/or TF) used by the MTC device operating as an MTC gateway in group A. The access enable signal (control information C2) including allocation information indicating allocation of radio resource RBβ further includes a common signal format (MCS and/or TF) used by the MTC device operating as an MTC gateway in group B.

(4) The video data transmitted by each of MTC devices 100A, 100B in group A is data based on the interleave division multiple access that is generated with interleave patterns different between MTC devices 100A, 100B. That is, even in the first group, video data is generated with different interleave patterns. Power consumption transmitted by each of MTC devices 100C, 100D in group B is data based on interleave division multiple access that is generated with interleave patterns different between MTC devices 100C, 100D.

(5) In the first application data format, the block size of data is defined at a predetermined value. In the second application data format, the block size of data is defined at a predetermined value.

(6) MTC devices 100A, 100B in group A have an image capturing function such as a monitoring camera. MTC devices 100A, 100B further have the same traffic distribution in the communication with base station device 200.

MTC devices 100C, 100D in group B have a power consumption measuring function such as an electric meter. MTC devices 100C, 100D further have the same traffic distribution in the communication with base station device 200.

<F. Control Structure>

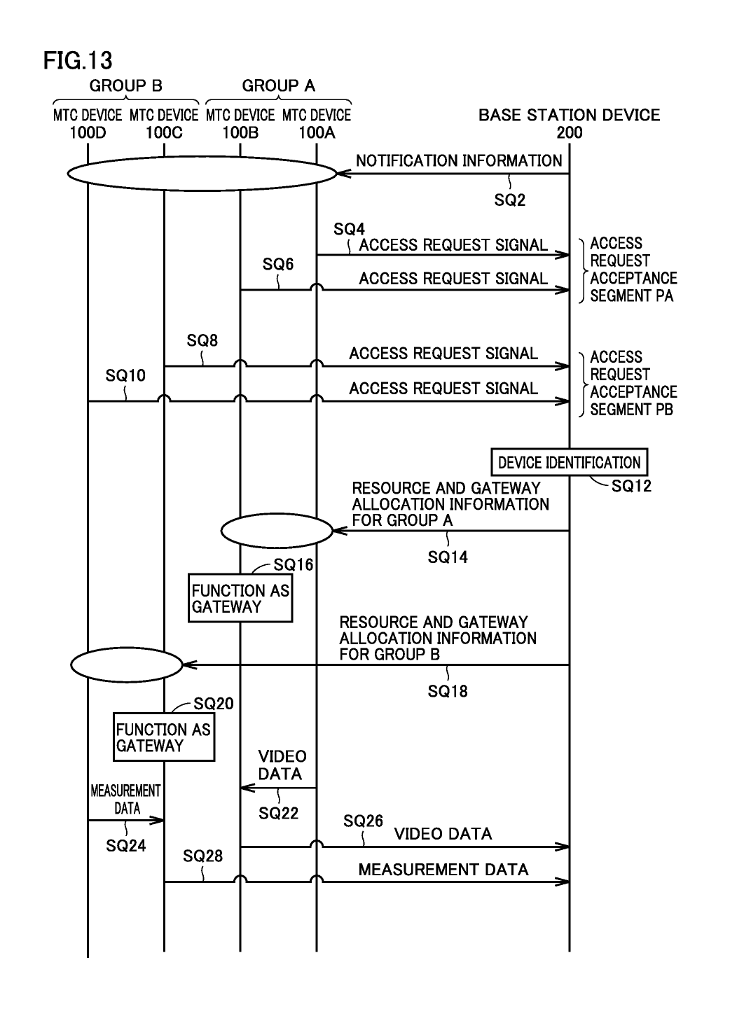

FIG. 13 is a sequence chart illustrating the procedure of the processing in wireless communication system 1. Each MTC device 100 performs position registration in advance and has an individual ID (for example, TMSI: temporary mobile subscriber identity) allocated as the device ID. The communication for position registration is not bound to the access request acceptance segment below. Alternatively, an ID (for example, IMEI: International Mobile Equipment Identity or IMSI: International Mobile Subscriber Identity) preset in, for example, a ROM (Read Only Memory) or a USIM (Universal Subscriber Identification Module) may be used as an individual device ID, without performing position registration.

Referring to FIG. 13, in sequence SQ2, each MTC device 100 (100A to 100D) receives notification information from base station device 200. Each MTC device 100 thereby receives information of the access request acceptance segment for the group to which the device belongs to.

Here, MTC devices 100 are configured such that MTC devices 100 in each group are able to receive only the information block including information of their group. A not-shown non-MTC device (a user terminal other than MTC devices 100) is set so as not to receive such information. The notification information includes a set of PRACH resource block allocation, signal format, and available preamble sequence. The preamble sequence is a signal sequence used when an access request is transmitted. Alternatively, base station device 200 may individually announce similar information to MTC devices 100 during position registration.

In sequence SQ4, MTC device 100A in group A selects the preamble pattern associated with the device's own ID and transmits an access request signal in the designated access request acceptance segment PA. In sequence SQ6, MTC device 100B in group A selects the preamble pattern associated with the device's own ID and transmits an access request signal in the designated access request acceptance segment PA.

In sequence SQ8, MTC device 100C in group B selects the preamble pattern associated with the device's own ID and transmits an access request signal in the designated access request acceptance segment PB. In sequence SQ10, MTC device 100D in group B selects the preamble pattern associated with the device's own ID and transmits an access request signal in the designated access request acceptance segment PB.

For example, assume that the ID is provided in 16 bits, and the number of preamble patterns is 512. MTC device 100 selects the preamble pattern corresponding to the lower nine bits of the ID. The preamble pattern is determined by a preamble sequence and a cyclic shift of the preamble sequence. Assuming that the sequence length is 839 in conformity with the pattern of PRACH of LTE, the above-noted number of patterns is ensured by a shift of one sequence. To increase the number of preamble patterns, the number of patterns may be increased by using a plurality of preamble sequences, or a preamble sequence having a long sequence length may be used.

In sequence SQ12, base station device 200 detects which preamble pattern is included in each of the signals received in access request acceptance segment PA and access request acceptance segment PB, for example, using a matched filter. Base station device 200 identifies MTC device 100 corresponding to the detected preamble pattern and then determines whether to perform transmission allocation. Since the IDs of MTC devices 100 have one-to-many correspondence to a preamble pattern, base station device 200 may not always uniquely specify MTC device 100. In this case, base station device 200 performs transmission allocation to a plurality of MTC devices belonging to the group for which an access request acceptance segment is set, among the IDs of MTC devices 100 corresponding to the preamble. If the number of MTC devices 100 belonging to a group is large, such measures as increasing the number of preamble patterns are taken in sequence SQ4, SQ6, SQ8, SQ10.

In sequence SQ14, base station device 200 transmits an access enable signal including resource allocation information and gateway allocation information collectively to MTC devices 100A, 100B for which transmission allocation is performed. That is, base station device 200 transmits control information C1 including resource allocation information and gateway allocation information for group A to MTC devices 100A, 100B in group A.

If the gateway allocation information included in control information C1 designates MTC device 100B to operate as a gateway, in sequence SQ16, MTC device 100B starts operation as an MTC gateway. MTC device 100A in the same group as MTC device 100B recognizes that MTC device 100B is designated as an MTC gateway.

In sequence SQ18, base station device 200 transmits an access enable signal including resource allocation information and gateway allocation information collectively to MTC devices 100C, 100D for which transmission allocation is performed. That is, base station device 200 transmits control information C2 including resource allocation information and gateway allocation information for group B to MTC devices 100C, 100D in group B.

If the gateway allocation information included in control information C2 designates MTC device 100C to operate as a gateway, in sequence SQ20, MTC device 100C starts operation as an MTC gateway. MTC device 100D in the same group as MTC device 100C recognizes that MTC device 100C is designated as an MTC gateway.

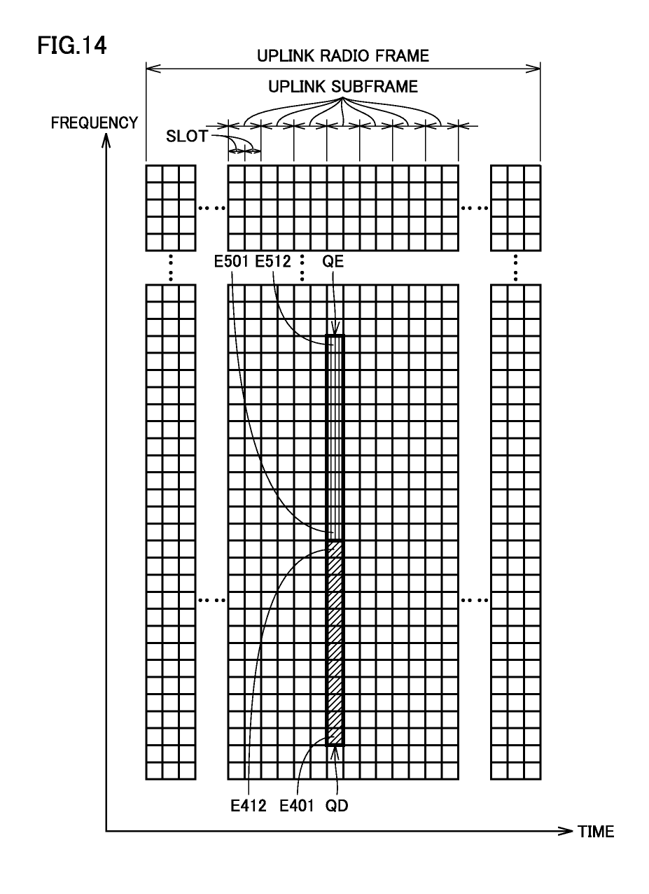

In sequence SQ22, MTC device 100A transmits video data to MTC device 100B functioning as an MTC gateway in group A, using radio resource designated in the local network including MTC device 100A. In sequence SQ26, MTC device 100B performs the processing of MDU on the video data received from MTC device 100A and the video data captured by MTC device 100B itself, and transmits the video data received from MTC device 100A and the video data captured by MTC device 100B itself to base station device 200, using the allocated radio resource (see FIG. 14). In this way, MTC device 100B not only transmits the video data captured by the device itself to base station device 200 but also relays the video data from MTC device 100A to base station device 200. Video data transmitted by each of MTC device 100A and MTC device 100B is generated using IDMA. MTC devices 100A, 100B use interleavers having patterns associated with the respective IDs of the devices.

Base station device 200 separately receives the signals of MTC devices 100A, 100B with the associated interleavers. The procedure of receiving the IDMA signal has been described and a description thereof is not repeated here.

In sequence SQ24, MTC device 100D transmits measurement data of power consumption to MTC device 100C functioning as an MTC gateway in group B, using radio resource designated in the local network including MTC device 100D. In sequence SQ28, MTC device 100C performs the processing of MDU on the measurement data received from MTC device 100D and the measurement data obtained through measurement by MTC device 100C itself, and transmits the measurement data received from MTC device 100D and the measurement data obtained through measurement by MTC device 100C itself to base station device 200, using the allocated radio resource (see FIG. 14). In this way, MTC device 100C not only transmits the measurement data obtained through measurement by the device itself to base station device 200 but also relays the measurement data from MTC device 100D to base station device 200. Power consumption data transmitted by each of MTC device 100C and MTC device 100D is generated using IDMA. MTC devices 100C, 100D use interleavers having patterns associated with the respective IDs of the devices.

Base station device 200 separately receives the signals of MTC devices 100C, 100D with the associated interleavers. The procedure of receiving the IDMA signal has been described and a description thereof is not repeated here.

The method described in NPD 3 does not carry out the procedure of access request and cannot identify which MTC device transmits. It is therefore necessary to try all interleavers in the base station device. However, in the method according to the present embodiment, since an access request is accepted in advance, it is only necessary to demodulate only the interleaver of MTC device 100 for which base station device 200 has performed transmission allocation.

During reception of the preamble in sequence SQ12, the state of the propagation path between MTC device 100 and base station device 200 may be determined, and the determination result may be used in the processing of MUD.

FIG. 14 is a diagram illustrating an example of the resource allocated to each MTC device in group A and group B.

Referring to FIG. 14, device 100B operating as an MTC gateway in group A transmits video data to base station device 200, for example, in the allocated segment QD. The segment QD is configured with 12 resource blocks in succession in the frequency direction, in a predetermined uplink subframe in one frame. Specifically, the segment QD is a segment defined by a resource block E401 and a resource block E412.

Device 100C operating as an MTC gateway in group B transmits measurement data to base station device 200, for example, in the allocated segment QE. The segment QE is configured with 12 resource blocks in succession in the frequency direction, in a predetermined uplink subframe in one frame. Specifically, the segment QE is a segment defined by a resource block E501 and a resource block E512.

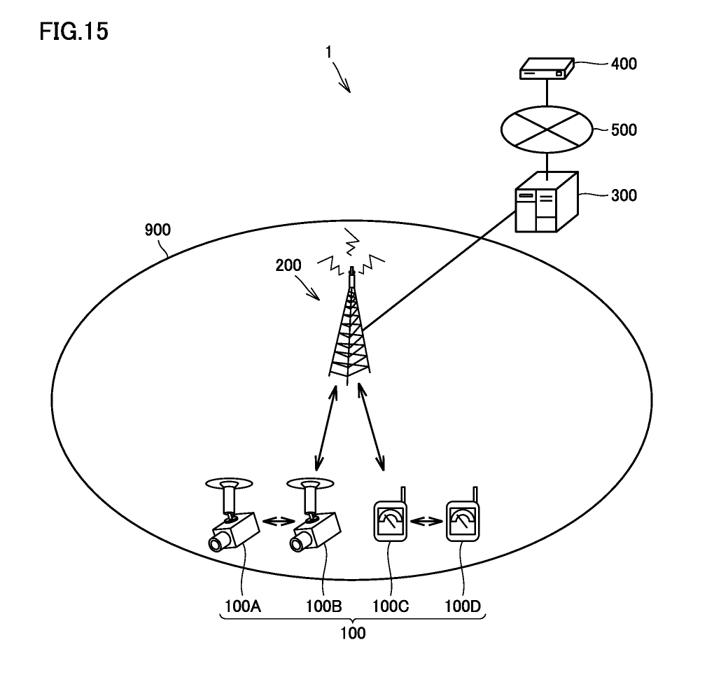

FIG. 15 is a diagram illustrating an aspect of communication in wireless communication system 1. Specifically, FIG. 15 is a diagram for explaining communication in sequence SQ22, SQ24, SQ26, SQ28 in FIG. 13. Referring to FIG. 15, MTC device 100B and MTC device 100C function as MTC gateways in groups A, B, respectively.

MTC device 100B receives video data from MTC device 100A and transmits the received video data together with video data acquired through image capturing by MTC device 100B, to base station device 200, as described above. MTC device 100C receives measurement data from MTC device 100D and transmits the received measurement data together with measurement data acquired through measurement by MTC device 100C, to base station device 200, as described above.

<G. Modification>

(g1. First Modification)

Wireless communication system 1 (for example, FIGS. 1, 15) described above includes two groups (groups A, B) and two gateways (MTC devices 100B, 100C). The number of groups and the number of gateways are not limited thereto. For example, the number of groups may be three, and the number of gateways may be three.

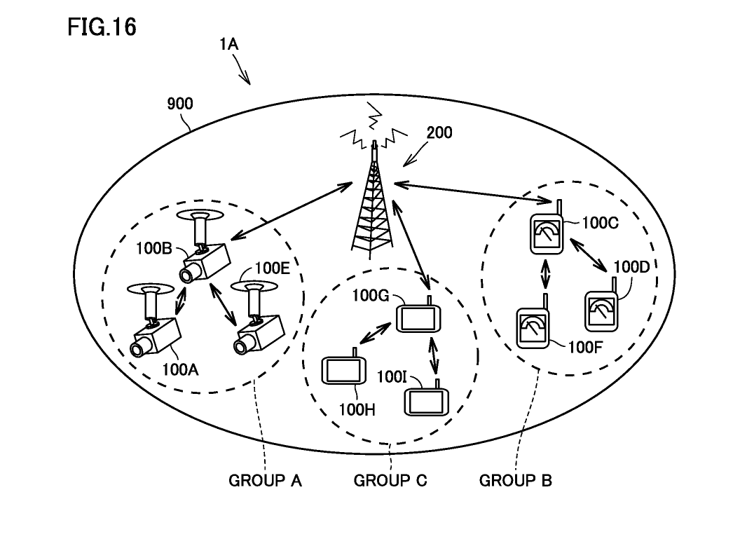

FIG. 16 is a diagram illustrating a schematic configuration of a wireless communication system 1A including three groups and three gateways. Referring to FIG. 16, wireless communication system 1A at least includes a plurality of MTC devices 100A to 100I, a base station device 200, an MME 300, and a server device 400. MTC devices 100A to 100I reside in cell 900 in which they can communication with base station device 200.

MTC devices 100E to 100I are communication devices that perform machine communication, similar to other MTC devices. MTC device 100E is a monitoring camera. MTC device 100F is an electric meter. MTC devices 100G, 100H, 100I are tablet terminals. MTC devices 100A, 100B, 100E constitute group A. MTC devices 100C, 100D, 100F constitute group B. MTC devices 100G, 100H, 100I constitute group C.

MTC device 100G operates an MTC gateway in the local network including MTC devices 100G, 100H, 100I. MTC device 100B operates an MTC gateway in the local network including MTC devices 100A, 100B, 100E. MTC device 100C operates an MTC gateway in the local network including MTC devices 100C, 100D, 100F. Data transmitted from MTC devices 100A to 100I is transmitted to server device 400 through base station device 200 and MME 300.

As described above, wireless communication system 1A has three groups (groups A, B, C) and three MTC gateways (MTC devices 100B, 100C, 100G).

(g2. Second Modification)

In the configuration of wireless communication system 1 described above, one MTC gateway is present in one group, by way of example. The embodiment, however, is not limited thereto. The wireless communication system may be configured to include a plurality of MTC gateways in one group.

For example, one group may be subdivided into subgroups according to the distance from the base station device or QoS, and one gateway is designated in each subgroup, whereby a plurality of gateways can be allocated to one group (see FIG. 8).

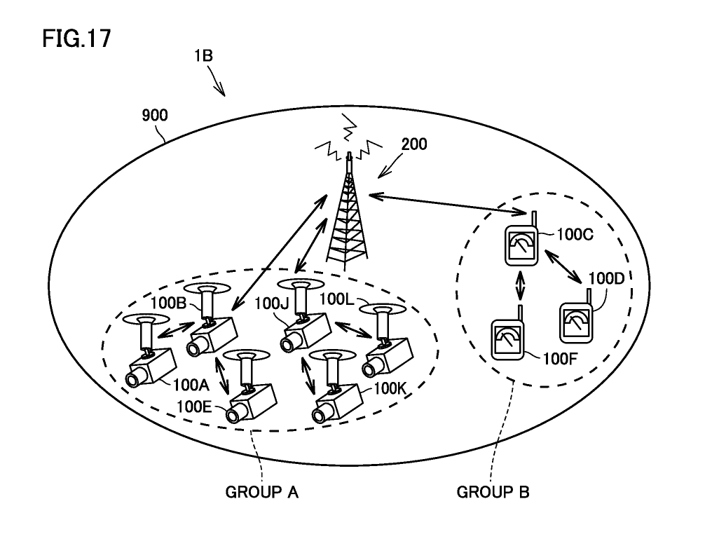

FIG. 17 is a diagram illustrating a schematic configuration of a wireless communication system 1B in which a plurality of gateways are allocated to one group. Referring to FIG. 17, wireless communication system 1B at least includes a plurality of MTC devices 100A to 100F, a plurality of MTC devices 100J, 100K, 100L, a base station device 200, an MME 300, and a server device 400. MTC devices 100A to 100F, 100J to 100L reside in cell 900 in which they can communication with base station device 200.

MTC devices 100J to 100L are communication devices that perform machine communication, similar to other MTC devices. MTC devices 100J to L are monitoring cameras. MTC devices 100A, 100B, 100E, 100J, 100K, 100L constitute group A. MTC devices 100C, 100D, 100F constitute group B.

MTC device 100J operates an MTC gateway in the local network including MTC devices 100J, 100K, 100L. MTC device 100B operates an MTC gateway in the local network including MTC devices 100A, 100B, 100E. MTC device 100C operates an MTC gateway in the local network including MTC devices 100C, 100D, 100F. Data transmitted from MTC devices 100A to 100F, 100J to L is transmitted to server device 400 through base station device 200 and MME 300.

As described above, in wireless communication system 1B, each of MTC devices not operating as MTC devices in group A transmits data to base station device 200, through one of a plurality of MTC gateways in the group.

When subgroups are classified by the distance, base station device 200 can efficiently set resource allocation for each MTC gateway in accordance with the quality of a signal transmitted by the MTC gateway to base station device 200.

When subgroups are classified by QoS, base station device 200 sets an MTC gateway for each degree of priority (high, middle, low) for MTC devices ranked by priority in advance, whereby the MTC gateway can transmit data reliably to base station device 200 even under severe time conditions that do not permit delay or stop of communication.

(g3. Third Modification)

The number of groups (m) may not always be equal to the number of gateways (n) as long as traffic concentration can be avoided. One gateway may be shared among a plurality of groups (m≧n>1). For example, the number of groups may be three and the number of gateways may be two.

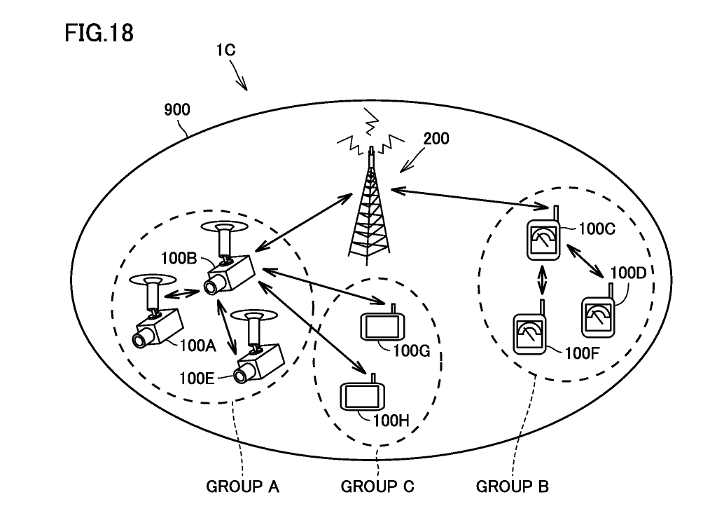

FIG. 18 is a diagram illustrating a schematic configuration of a wireless communication system 1C including three groups and two gateways. Referring to FIG. 18, MTC devices 100A, 100B, 100E constitute group A. MTC devices 100C, 100D, 100F constitute group B. MTC devices 100G, 100H constitute group C.

MTC device 100B operates an MTC gateway in the local network including MTC devices 100A, 100B, 100E (the local network of group A) and the local network including MTC devices 100G, 100H (the local network of group C). MTC device 100C operates an MTC gateway in the local network including MTC devices 100C, 100D, 100F.

The configuration of wireless communication system 1C as described above can avoid traffic concentration and have an appropriate number of gateways. Accordingly, the MTC gateway can efficiently connect to base station device 200.

In this case, after groups are classified according to format 8 shown in FIG. 8, the gateway resource information, the gateway MCS, and the gateway TF are set to be identical information in each group, and the gateway flag sets a single MTC device. In the case in FIG. 8, gateway resource information _{VA} and gateway resource information _{VB} have the same value, gateway MCS_{A} and gateway MCS_{B} have the same value, and gateway TF_{A} and gateway TF_{B} have the same value. The gateway flag is designated such that a single appropriate MTC device serves as an MTC gateway. Groups A, C in FIG. 18 are formed through such a procedure.

In the foregoing description, the MTC device allowed to operate as an MTC gateway is determined by base station device 200, by way of example. The embodiment, however, is not limited thereto. For example, wireless communication systems 1, 1A, 1B, 1C may be configured such that a device on a level higher than base station device 200, such as MME 300 or server device 400, determines the MTC device to operate as an MTC gateway.

The embodiment disclosed here should be understood as being illustrative rather than being limitative in all respects. The scope of the present invention is shown not in the foregoing description but in the claims, and it is intended that all modifications that come within the meaning and range of equivalence to the claims are embraced here.

### DESCRIPTION OF THE REFERENCE SIGNS

1, 1′ wireless communication system, 100, 100A to 100H, 100SC, 100PM MTC device, 101, 202 transmission unit, 102, 203 reception unit, 103 path loss calculation unit, 104, 205 comparison unit, 105 positional information acquisition unit, 110 CPU, 111 memory, 112 communication processing circuit, 113 wireless IF, 114 sensor, 115 converter, 116 timer, 117 power supply control circuit, 118 power supply, 119 GPS receiver, 119 MTC-GW processing unit, 120 short-range network processing unit, 121 short-range network IF unit, 200, 200′ base station device, 201 allocation unit, 204 distance calculation unit, 210 antenna, 230 wireless processing unit, 250 baseband unit, 251 baseband circuit, 252 control device, 253 timing control unit, 254 communication interface, 255 power supply device, 300 MME, 400 server device, 810, 820 area, 900 cell, E1, E6, E11, E16, E21, E26, E101, E108, E201, E210, E301, E310, E401, E411 resource block, QA, QB, QC, QD segment.

1. A wireless communication system comprising: a plurality of communication devices each performing machine communication; and a base station device performing wireless communication with the plurality of communication devices,
the base station device including
a reception unit for receiving a request signal for requesting access to the base station device from, of the plurality of communication devices, each of communication devices in a first group that can transmit data to the base station device using a first application data format, and
an allocation unit for allocating first radio resource to a communication device operating as a gateway, of the communication devices in the first group,
the communication device operating as the gateway including
a reception unit for receiving the data from each communication device not operating as the gateway in the first group, and
a transmission unit for transmitting the data received from each communication device not operating as the gateway, to the base station device using the first radio resource.

2. The wireless communication system according to claim 1, wherein each of the communication devices in the first group transmits, to the base station device, a request signal for requesting access to the base station device, using second radio resource.

3. The wireless communication system according to claim 2, wherein
the base station device
determines a communication device to function as the gateway from among the communication devices in the first group, and
announces information for specifying the gateway in the first group to each of communication devices other than the communication device to function as the gateway in the first group, through the base station.

4. The wireless communication system according to claim 2, wherein
the base station device allows, of the communication devices in the first group, a plurality of communication devices to function as gateways, and
of a plurality of communication devices in the first group, each communication device not operating as a gateway transmits the data to the base station device through any one of the gateways.

5. The wireless communication system according to claim 1, wherein
of the plurality of communication devices, each of communication devices in a second group that transmit data to the base station device using a second application data format transmits the data to the base station device, through the communication device operating as a gateway in the first group.
